(19) United States
(12) Patent Application Publication
(10) Pub. No.: US 2021/0209538 A1
(43) Pub. Date: Jul. 8, 2021

(54) System for Matching Jobs in an Activity

(71) Applicant: Hope Yuan-Jing Chung, Taichung City (TW)

(72) Inventor: Hope Yuan-Jing Chung, Taichung City (TW)

(21) Appl. No.: 16/931,617

(22) Filed: Jul. 17, 2020

(30) Foreign Application Priority Data
Jan. 7, 2020 (CN) 202010012652.2

(51) Int. Cl. G06Q 10/06; G06K 9/00; G06F 16/901; H04W 4/029

(52) U.S. Cl. CPC G06Q 10/063112; G06Q 10/06398; H04W 4/029; G06F 16/901; G06K 9/00315

(57) ABSTRACT

A system for matching jobs in an activity has a digital diary module, an activity test module, and a matching module. The digital diary module collects a student's emotion score, personality score and motivation score. The activity test module is connected to the digital diary module. The activity test module stores a plurality of experimental activity data and receives the emotion score, the personality score and the motivation score. The matching module is connected to the activity test module, wherein the matching module receives the emotion score, the personality score, and the motivation score of each student and receives an actual activity data input by an administrator of the system. The matching module assigns each student to a respective one of the jobs in the activities according to the emotion score, the personality score, and the motivation score.

### BACKGROUND OF THE INVENTION

### 1. Field of the Invention

The present invention relates to a system, more particularly to a learning system for matching jobs in an activity for students.

### 2. Description of the Related Art

Humans have always been social animals. Since ancient times, through continuous interaction and cooperation, people have accomplished many great achievements and created immortal civilizations. In the modern era, people still achieve their common goals through large and small cooperation, as small as families, and as large as companies and countries.

When a group of people participates in an activity in order to achieve a goal, the division of labor becomes crucial, as appropriate allocation of tasks makes everyone in the group fully utilize their strengths. The activity can have the most efficient result. To find a best way to achieve the best result is an important issue in every group. The better people in the group understand each other, the better the activity will be executed. Assigning the right people to the right position can optimize the outcome of the activity.

In the past, assigning everyone to his suitable position is based on impressions. For example, someone often acts as the event's general coordinator, so he may continuously act as the general coordinator for this event. Someone is good at socializing, so he is assigned to handle public relations. However, this allocation is based only on everyone's superficial impression of each other, so some people may be assigned to work at which they are not good, causing poor execution of the activity.

### SUMMARY OF THE INVENTION

The present invention provides a system for matching jobs in an activity. The system avoids assigning the activity or positions based on the subjective impressions. The system collects and digitizes each student's characteristic data including personality and academic scores. By collecting each student's personality data and scores, a matching module assigns each student to a suitable position in an activity based on the collected data.

The system comprises:

a digital diary module collecting a student's emotion score, personality score and motivation score, and including:
a digital diary database storing a plurality of digital dairy books, wherein each digital dairy book contains a plurality of digital diaries, the student keeping the digital diaries to record daily activities;
an emotion database storing a plurality of emotion keywords;
a personality database storing a plurality of personality keywords;
a motivation database storing a plurality of motivation keywords; and
a scanning unit electrically connected to the emotion database, the personality database and the motivation database; wherein the scanning unit searches the digital diaries of multiple students and retrieves a plurality of diary keywords from the digital diaries kept by the multiple students;

the scanning unit comparing the plurality of diary keywords with the emotion keywords stored in the emotion database, the personality keywords in the personality database and the motivation keywords in the motivation database;

when any one of the diary keywords matches any of the keywords stored in the emotion database, in the personality database and in the motivation database, the scanning unit generating the emotion score, the personality score or the motivation score according to the diary keywords;

an activity test module connected to the digital diary module, storing a plurality of experimental activity data and receiving the emotion score, the personality score, and the motivation score of each student, wherein the plurality of experimental activity data are inputted by an administrator of the system;

the activity test module matching each student to a respective job according to the emotion score, the personality score and the motivation score of each student and generating an activity test score;

a matching module connected to the activity test module, wherein the matching module receives the emotion score, the personality score, the motivation score of each student and receives an actual activity data input by the administrator of the system;

the matching module assigning each student to a respective one of the jobs in an actual activity in the actual activity data according to the emotion score, the personality score, and the motivation score.

The system can quantify each student's various abilities and find out the strengths and the best learning mode in the participation in and matching of activities. The system provides each student with better understanding of the learning mode suitable for him. Each student can find the way he wants to progress and the motivation moving toward the goal. In addition, the system can increase learning efficiency for each student. Further, each student can be matched to a suitable job in the activity, so that each student can participate in the activity in a way that suits him. The activity can accomplish the best results in the most efficient way.

### BRIEF DESCRIPTION OF THE DRAWINGS

FIG. 1 is a circuit block diagram of the present invention;

FIG. 2 is a circuit block diagram of the digital diary module of the present invention;

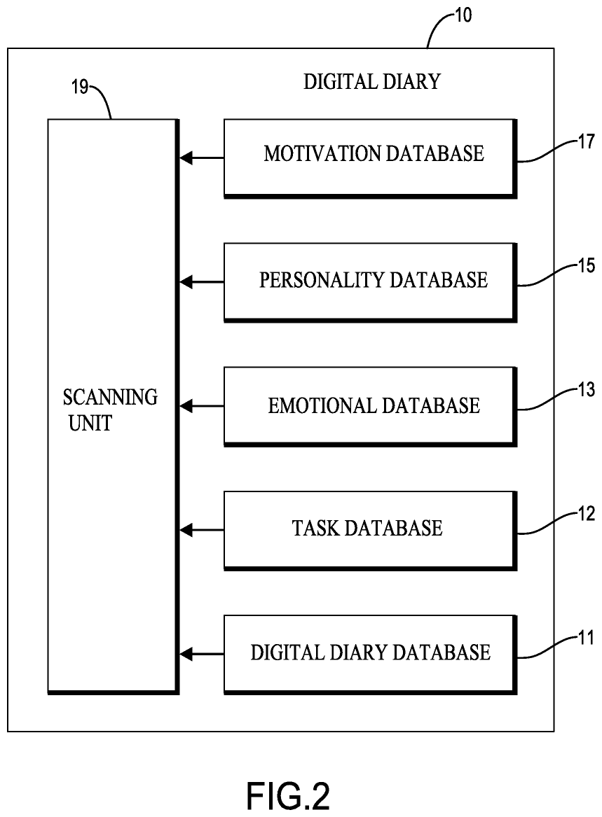

FIG. 3 is a circuit block diagram of the progress management module of the present invention; and

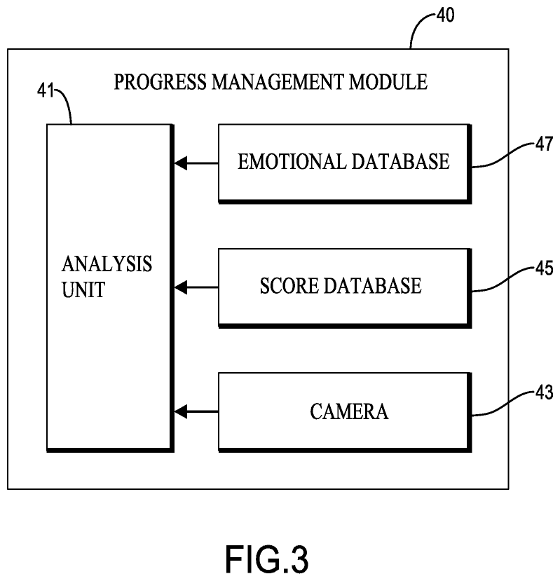

FIG. 4 is a schematic view of the participation rate.

### DETAILED DESCRIPTION OF THE INVENTION

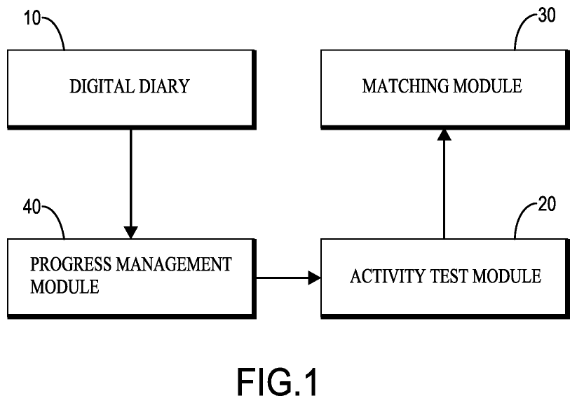

Referring to FIG. 1, the present invention provides a system for matching jobs in an activity. The system comprises a digital diary module 10, an activity test module 20, a matching module 30 and a progress management module 40. The digital diary module 10 is connected to the activity test module 20 through the progress management module 40. The activity test module 20 is connected to the matching module 30.

The digital diary module 10 collects a student's emotion score, personality score and motivation score, and includes a digital diary database 11, a task database 12, an emotion database 13, a personality database 15, a motivation database 17 and a scanning unit 19. The digital diary database 11, the task database 12, the emotion database 13, the personality database 15 and the motivation database 17 are electrically connected to the scanning unit 19 respectively.

The digital diary database 11 stores a plurality of digital dairy books. Each digital diary book contains a plurality of digital diaries. Each student may keep the digital diary to record his daily activities. Viewers who can browse the digital diary can leave a message for the digital diary. Each student has a respective digital diary book.

The task database 12 stores digital task books each corresponding to a respective student. Each digital task book records each student's task types, degrees of task completion, time for completing the task, emotion data during the task, event records, rewards requested after completing the task, and messages left by the viewers browsing the digital task book.

For example, an administrator of the system can assign a task of “learning to play a piano composition” to one of the students, and set the completion time of the task (for example, one month). If the task is completed before the deadline, the student can win a reward such as a piano charm. In order to win the piano charm, the student must practice repeatedly to play the specified piano composition skillfully within one month. During the practice, the student records task keywords in the digital task book. The plural task keywords represent the emotion and difficulties encountered in performing the task. If the student completes the task within one month, the student wins the reward after the administrator of the system confirms completion of the task. If the student completes the task later than one month, or does not complete the task, the student cannot win the reward. The task database 12 records a degree of task completion and the time of task completion for each student. By recording the degree of task completion and the time of task completion for each student, the task database 12 determines the student's motivation for the task, and further finds the motivation for learning and favorite rewards suitable for the students' learning. It lets each student study in the most suitable way.

The emotion database 13 stores a plurality of emotional keywords such as “happy”, “pleasant” and “sad”.

The personality database 15 stores a plurality of personality keywords such as “generous”, “self-centered”, “polite” and “cultivated”.

The motivation database 17 stores a plurality of motivation keywords such as “weight loss”, “10 places higher in ranking for the exam”, “run 3000 meters within 15 minutes”, and “finish reading a book”.

The scanning unit 19 searches each digital diary book and each digital task of each student. The scanning unit 19 retrieves a plurality of diary keywords in the digital diary and the plurality of task keywords recorded in the digital task book. The scanning unit 19 compares the plurality of diary keywords and the plurality of task keywords with the keywords stored in the emotion database 13, in the personality database 15 and in the motivation database 17. When any one of the diary keywords matches any of the keywords stored in the emotion database 13, in the personality database 15 and in the motivation database 17, the scanning unit 19 converts the diary keywords and the task keywords into the emotion score and the motivation score respectively.

For example, when the student records “happy”, “pleasure” and other diary keywords in the digital diary, the digital diary module 10 retrieves the plurality of diary keywords and compares them with the keywords stored in the emotion database 13, in the personality database 15 and in the motivation database 17. When the scanning unit 19 compares the keywords “happy” and “pleasure” recorded in the digital diary and finds that the keywords are also stored in the emotion database 13, the scanning unit 19 will generate the emotion score according to the keywords “happy” and “pleasure”. It means that the student is very happy today. Similarly, if the student records “polite” and “cultivated” and other diary keywords in the digital diary, the digital diary module 10 retrieves the plural diary keywords and compares them with the keywords stored in the emotion database 13, in the personality database 15 and in the motivation database 17. When the scanning unit 19 compares the keywords “polite” and “cultivated” with the keywords “polite” and “cultivated” stored in the emotion database 13, in the personality database 15 and in the motivation database 17, the scanning unit 19 generates the personality score according to the keywords “polite” and “cultivated”. It means that the student is polite and cultivated. Similarly, if the student writes down “diet”, “finish reading a book” and other diary keywords in the digital diary, the scanning unit 19 generates the motivation score according to the keywords “diet”, “finish reading a book” and other diary keywords.

The progress management module 40 comprises an analysis unit 41, a camera 43, a score database 45, and an emotion score database 47. The camera 43 captures each student's expression data during class. The score database 45 stores personal data and score data of each student. The emotion database 47 stores a plurality of basic emotional data, wherein each basic emotional data represents a respective kind of emotion. The analysis unit 41 is electrically connected to the camera 43, the score database 45 and the emotion score database 47. The analysis unit 41 collects the expression data and compares the expression data to the plurality of basic emotional data in order to determine the student's emotion in class and generate an emotion score.

For example, if a student's pleasant expression accounts for 80% of the class time, and an impatient expression accounts for 20% of the class time, it means that the student's is pleasant. It can be further determined that the student is interested in this class.

The activity test module 20 stores a plurality of experimental activity data and receives the emotion score, the personality score, and the motivation score of each student. The plurality of experimental activity data is inputted by the administrator of the system. Each experiment activity data represents an activity in which the students can participate. The activity includes a plurality of jobs. The activity test module 20 appropriately matches each student to a respective one of the jobs according to the emotion score, the personality score and the motivation score of each student. The activity test module 20 then generates an activity test score. The activity test score represents the performance of each student in his job. For example, if the student's emotion score includes “comfortable”, “peaceful” and “pleasant” and the personality score includes “steady” and “calm”, it means the student has the capability for leadership and can complete the activity harmoniously. The activity test module 20 will assign the student as the general coordinator of the activity. When the activity is completed, the activity test module 20 will receive an execution score. The execution score is the score for evaluating the students' performance and is given by the administrator of the system. The higher the execution score, the better the student's performance in the job, and vice versa. It should be noted that the plurality of experimental activity data stored in the activity test module 20 are about experimental activities designed by the administrator of the system to test the performance of each student in different positions in different activities.

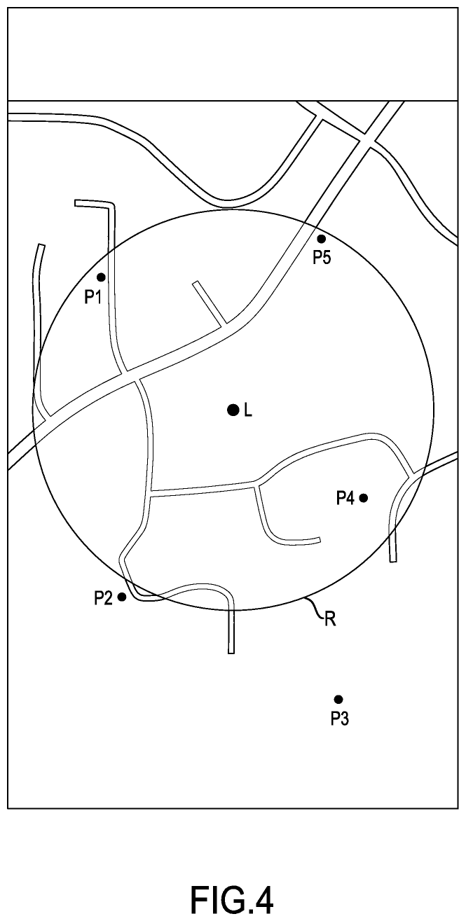

Referring to FIG. 4, the activity test module 20 can also record a participation rate. The participation rate represents the attendance status of each student participating in the activity. Taking FIG. 4 as an example, the activity test module 20 stores an activity location L, an activity range R and obtains the positions P1˜P5 of different students. The activity location L represents the position where the activity is held. The activity range R is a circular area with the activity location L as the center and a certain distance (for example, 200 meters) as the radius. Five students are located in the positions P1˜P5. The position P1˜P5 can be obtained by GPS data provided by smart phones carried by the students. If a student stays in the activity range R for more than a threshold time (for example, 15 minutes), the activity test module 20 determines that the student has attended the activity. If a student stays in the activity range R less than the threshold time and does not even move to the vicinity of the activity range R, it means that the student does not attend the activity. By the way as mentioned above, the activity test module 20 obtains the student's participation rate of the activity. In this way, the participation rate of the activity can be used as a reference for evaluating the student's attitude and motivation for the participation in or execution of the activity.

The matching module 30 receives the emotion score, the personality score, the motivation score, the participation rate and the execution score of each student, and receives an actual activity data provided by the administrator of the system. The actual activity data represents an actual event. The matching module 30 assigns each student to one of the jobs in the actual activity according to the emotion score, the personality score, the motivation score and the execution score. In the preferred embodiment of the system, the matching module 30 executes a Hungarian algorithm to match the positions of each student.

The matching module 30 can further analyze each student's emotion changes, personality changes and motivation changes after receiving the emotion scores, personality scores and motivation scores of each student. For example, if a student records the words “happy”, “pleasure”, “happiness” etc. in the digital diary, then the matching module 30 gives the emotion score according to the mood represented by the plural diary keywords. For example, if there are three diary keywords of positive emotion, the matching module 30 sets the emotion score to 70 points. If there are five diary keywords of positive emotion, the matching module 30 sets the emotion score to 80 points. Conversely, if there are three diary keywords of negative emotion, the matching module 30 sets the emotion score to 30 points. If there are five diary keywords of negative emotion, the matching module 30 sets the emotion score to 10 points. The system can analyze each student's daily emotion changes and instantly understand the student's emotional fluctuations. The administrator of the system or the teachers can offer assistance when the students need further care or help.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A system for matching jobs in an activity comprising:
a digital diary module collecting a student's emotion score, personality score and motivation score, and including:
a digital diary database storing a plurality of digital dairy books, wherein each digital dairy book contains a plurality of digital diaries, the student keeping the digital diaries to record daily activities;
an emotion database storing a plurality of emotion keywords;
a personality database storing a plurality of personality keywords;
a motivation database storing a plurality of motivation keywords; and
a scanning unit electrically connected to the emotion database, the personality database and the motivation database; wherein the scanning unit searches the digital diaries of multiple students and retrieves a plurality of diary keywords from the digital diaries kept by the multiple students;
the scanning unit comparing the plurality of diary keywords with the emotion keywords stored in the emotion database, the personality keywords in the personality database and the motivation keywords in the motivation database;
when any one of the diary keywords matches any of the keywords stored in the emotion database, in the personality database and in the motivation database, the scanning unit generating the emotion score, the personality score or the motivation score according to the diary keywords;
an activity test module connected to the digital diary module, storing a plurality of experimental activity data and receiving the emotion score, the personality score, and the motivation score of each student, wherein the plurality of experimental activity data are inputted by an administrator of the system;
the activity test module matching each student to a respective job according to the emotion score, the personality score and the motivation score of each student and generating an activity test score;
a matching module connected to the activity test module, wherein the matching module receives the emotion score, the personality score, the motivation score of each student and receives an actual activity data input by the administrator of the system;
the matching module assigning each student to a respective one of the jobs in an actual activity in the actual activity data according to the emotion score, the personality score, and the motivation score.

2. The system as claimed in claim 1, further comprising a progress management module, the digital diary module connected to the activity test module through the progress management module; the progress management module comprising:
a camera capturing each student's expression data during class;
a score database storing personal data and score data of each student;
an emotion score database storing a plurality of basic emotional data, wherein each basic emotional data represents a respective kind of emotion;
an analysis unit electrically connected to the camera, the score database and the emotion score database, wherein the analysis unit collects the expression data and compares the expression data to the plurality of basic emotional data in order to determine the student's emotion in class and generate the emotion score.

3. The system as claimed in claim 2, wherein the matching module executes a Hungarian algorithm to match the jobs for each student.

4. The system as claimed in claim 3, wherein the activity test module stores an activity location and an activity range and obtains positions of each of the students, wherein when the student stays in the activity range for more than a threshold time, the activity test module determines that the student has attended the activity; and
the positions are obtained by GPS data provided by smart phones carried by the students.

5. The system as claimed in claim 4, wherein the activity test module further receives the emotion score to assign the jobs to each student in the activity according to the emotion score, the personality score and the motivation score and an execution score of each student, wherein the execution score evaluates the students' performance and is given by the administrator of the system.

6. The system as claimed in claim 4, comprising a task database, wherein
the task database is electrically connected to the scanning unit and stores digital task books corresponding to each student;
each digital task book recording each student's task types, degrees of task completion, time for completing the task, emotion during the task, event records, rewards requested after completing the task and messages left by viewers browsing the digital task book.

7. The system as claimed in claim 6, wherein the matching module receives the emotion score, the personality score, the motivation score and a participation rate of each student and assigns each student to a respective one of the jobs in the activity;
wherein the participation rate is used as a reference for evaluating the student's participation in or execution of the activity.
